(19) United States
(12) Patent Application Publication
(10) Pub. No.: US 2017/0083579 A1
(43) Pub. Date: Mar. 23, 2017

(54) DISTRIBUTED DATA PROCESSING METHOD AND SYSTEM

(71) Applicant: ALIBABA GROUP HOLDING LIMITED, George Town (KY)

(72) Inventors: Chuan DU, Beijing (CN); Shan LI, Beijing (CN); Peile DUAN, Beijing (CN); Pumeng WEI, Beijing (CN); Jing SUN, Beijing (CN)

(21) Appl. No.: 15/266,897

(22) Filed: Sep. 15, 2016

(30) Foreign Application Priority Data
Sep. 18, 2015 (CN) 201510599863.X

(51) Int. Cl. G06F 17/30; H04L 29/08

(52) U.S. Cl. CPC G06F 17/30486; H04L 67/10; G06F 17/30339; G06F 17/30864; G06F 17/30091; G06F 17/30371; G06F 17/30156; G06F 17/30106

(57) ABSTRACT

A distributed data processing method is provided. The distributed data processing method includes: receiving, by a shard node, data uploaded by a client, wherein the data is directed to a table; storing, by the shard node, the data to a storage directory corresponding to the table; and when the storage is successful, sending, by the shard node, the data to each connected stream computing node to perform stream computing.

### CROSS-REFERENCE TO RELATED APPLICATION

This application is based upon and claims priority to Chinese Patent Application No. 201510599863.X, filed Sep. 18, 2015, the entire contents of which are incorporated herein by reference.

### TECHNICAL FIELD

The present application relates to the field of computing technology and, more particularly, to a distributed data processing method and system.

### BACKGROUND

As the Internet develops rapidly, cloud computing technology has been widely applied. Distributed mass data processing is an application of the cloud computing. The distributed mass data processing is approximately classified into two types of computing models: off-line processing and stream computing. The off-line computing executes query computation on a known data set, such as the off-line computing model “MapReduce.” For the stream computing, data is unknown and arrives in real time, and the data is processed according to a predefined computing model as it arrives.

For different computing models, the requirements for persistent storage of data may vary. The off-line computing performs query computation on a known data set that exists before the computation, and thus, the requirements on data persistence is relative low, as long as the data can be correctly written into a distributed file system according to a certain format. In the stream computing, data arrives at a pre-defined computing model continuously, and problems such as data loss, repetition, and disorder caused by various abnormal factors need to be taken into consideration, thereby demanding higher requirements on the data persistence.

The off-line computing and stream computing models have different characteristics and may be used in different application scenarios. In some applications, the same data may need to be processed in real time by the stream computing, and also need to be stored for usage by the off-line computing. In this case, a unified data storage mechanism is required.

Conventionally, a message queue is used to serve as a middle layer of the data storage, so as to shield the incoming data from the differences between back-end computing models. This method, however, does not recognize the differences between the computing models. For the off-line computing, data required for computing is generally organized in the distributed file system in advance according to a certain format. To use a message queue for data storage, an off-line computing system needs an additional data middleware to retrieve data from the message queue, and to store the data in the distributed file system according to requirements of the off-line computing. Thus, the conventional method increases the system complexity and also adds another data storage process, thereby causing an increase of storage cost, error probability, and processing delay.

### SUMMARY

The present disclosure provides a distributed data processing method. Consistent with some embodiments, the distributed data processing method comprises: receiving, by a shard node, data uploaded by a client, wherein the data is directed to a table; storing, by the shard node, the data to a storage directory corresponding to the table; and when the storing is successful, sending, by the shard node, the data to a connected stream computing node to perform stream computing.

Consistent with some embodiments, this disclosure provides a distributed data processing system comprising: one or more shard nodes and one or more stream computing nodes. Each of the shard nodes comprises: a data receiving module configured to receive data uploaded by a client, wherein the data is directed to a table; a data storing module configured to store the data to a storage directory corresponding to the table; and a data forwarding module configured to, when the storage is successful, send the data to a connected stream computing node to perform stream computing.

Consistent with some embodiments, this disclosure provides a non-transitory computer readable medium that stores a set of instructions that are executable by at least one processor of a shard node to cause the shard node to perform a distributed data processing method. The distributed data processing method comprises: receiving, by a shard node, data uploaded by a client, wherein the data is directed to a table; storing, by the shard node, the data to a storage directory corresponding to the table; and when the storage is successful, sending, by the shard node, the data to each connected stream computing node to perform stream computing.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram illustrating an Apache Kafka computing system.

FIG. 2 is a schematic diagram illustrating a data persistence method used in an Apache Kafka computing system.

FIG. 3 is a flowchart of an exemplary method for distributed data processing, consistent with some embodiments of this disclosure.

FIG. 4 is a block diagram of an exemplary distributed computing system, consistent with some embodiments of this disclosure.

FIG. 5 is a schematic diagram illustrating an exemplary data processing method, consistent with some embodiments of this disclosure.

FIG. 6 is a schematic diagram illustrating an exemplary data structure, consistent with some embodiments of this disclosure.

FIG. 7 is a schematic diagram illustrating an exemplary stream computing method, consistent with some embodiments of this disclosure.

FIG. 8 is a flowchart of an exemplary method for distributed data processing, consistent with some embodiments of this disclosure.

FIG. 9 is a block diagram of an exemplary system for distributed data processing, consistent with some embodiments of this disclosure.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

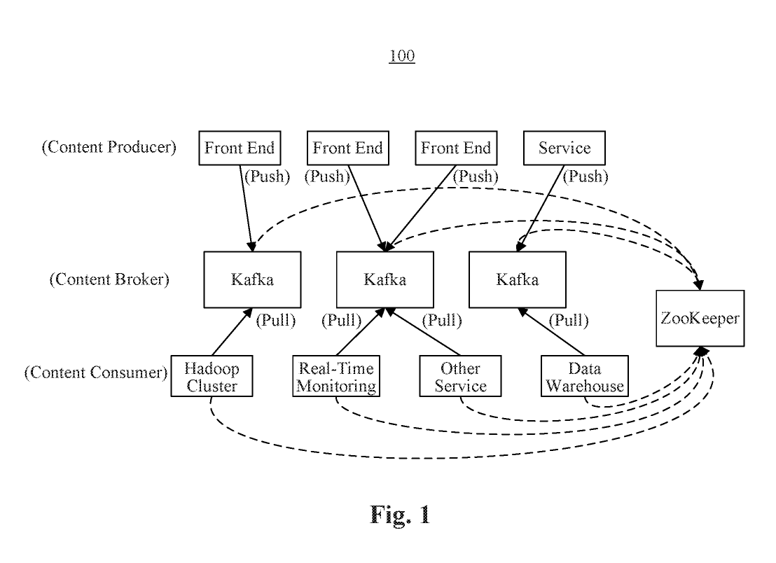

FIG. 1 is a schematic diagram illustrating an Apache Kafka computing system 100. In FIG. 1, a stream computing model named Apache Kafka is used. As shown in FIG. 1, the Apache Kafka computing system 100 includes one or more content producers, such as Page Views generated by a web front end, service logs, system CPUs, memories, or the like. The Apache Kafka computing system 100 further includes one or more content brokers, such as Kafka, supporting horizontal extension, and generally, a greater number of content brokers results in higher cluster throughput. The Apache Kafka computing system 100 further includes one or more content consumer groups (e.g., Hadoop clusters, real-time monitoring systems, other services, data warehouses, etc.) and a Zookeeper cluster.

In the Apache Kafka computing system 100, Kafka is designed to manage cluster configuration by using the Zookeeper, select a server as the leader, and perform load rebalance when the content consumer groups change. The content producer publishes a message to the content broker by using a push mode, and the content consumer subscribes to the message from the content broker by using a pull mode and processes the message.

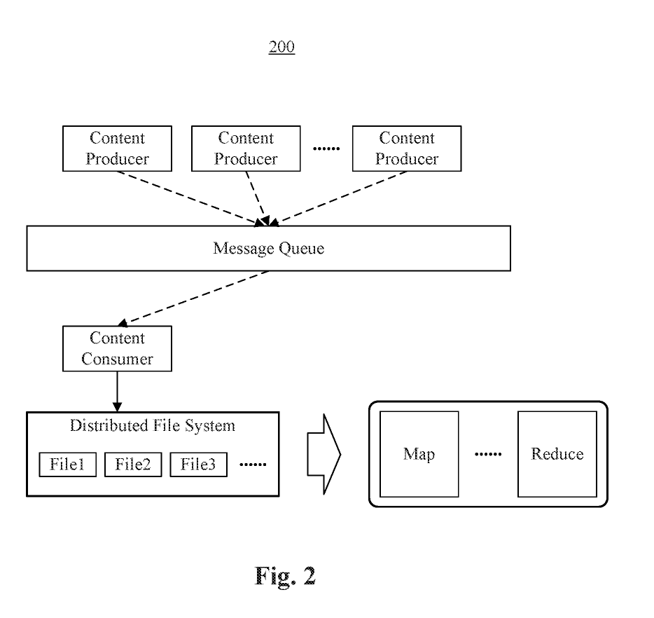

FIG. 2 is a schematic diagram illustrating a data persistence method 200 used in an Apache Kafka computing system. As shown in FIG. 2, a message queue represented by Kafka is used as a middle layer of data persistence, and the content producer sends data to the content consumer, thereby shielding the difference of the back-end computing model. Content consumers pull data, such as Files 1-3, from the message queue system to the Distributed File System, so as to perform distributed processing, such as MapReduce.

In a stream computing model, problems such as data loss, duplication, and out of order may occur and need to be taken into consideration. To solve these problems, it is generally required that a data source of the stream computing provide additional information of the data, for example, a unique identification for each piece of data, and the like. In the message queue, the content producer and the content consumer are decoupled, making it difficult to acquire the additional information in order to solve these problems in a stream computing system.

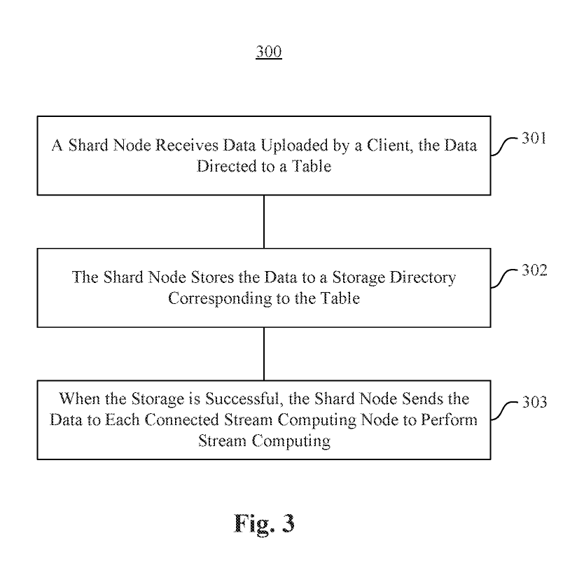

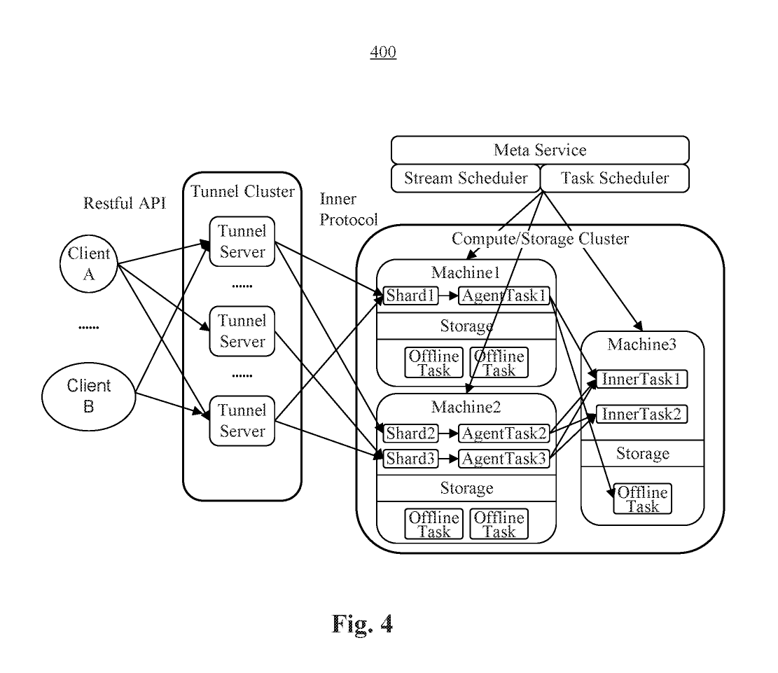

FIG. 3 is a flowchart of an exemplary method 300 for distributed data processing, consistent with some embodiments of this disclosure. The method 300 may be applied to a distributed system, such as the system 400 shown in FIG. 4. Referring to FIG. 3, the method 300 includes the following steps.

In step 301, a shard node receives data uploaded by a client for a table. As shown in FIG. 4, the distributed system may provide, to an external system, an Application Programming Interface (API), e.g., an API meeting Restful specifications, such that a user may perform data uploading by invoking a corresponding Software Development Kit (SDK) in a program via a client such as a web console. The uploaded data may be any data structure such as website access logs, user behavior logs, and transaction data, which is not limited by the present disclosure.

For example, a format of a website access log is: (ip, user, time, request, status, size, referrer, agent), and an example website access log is: 69.10.179.41, 2014-02-12 03:08:06, GET/feed HTTP/1.1, 200, 92446, Motorola. As another example, a format of a user behavior log is: (user_id, brand_id, type, date), and an example user behavior log is: 10944750, 21110, 0, 0607.

As shown in FIG. 4, the distributed system interacts with the client through a tunnel cluster. The tunnel cluster consists of a series of tunnel servers, and the tunnel servers are responsible for maintaining client connection, client authentication and authorization, and traffic control, and so on. In some implementations, the tunnel servers do not directly participate in real-time or off-line computing.

The data uploaded by the client may be forwarded to a computing cluster by the tunnel servers. The computing cluster is a distributed computing and/or storage cluster established on numerous machines, such as machines 1-3 shown in FIG. 4. The computing cluster provides a virtual compute and/or storage platform by integrating the resources, memories, and/or storage resources of the numerous machines.

The computing cluster (designated in FIG. 4 as compute/storage cluster) is controlled by a control node. The control node includes a meta service, a stream scheduler, and a task scheduler. The meta service is responsible for managing and maintaining the storage resources in the computing cluster, and maintaining abstract data information, such as a table and a schema, that is constructed based on data stored in a lower level storage. As the same cluster may handle multiple streams simultaneously, the stream scheduler may be responsible for coordinating operations such as resource distribution and task scheduling of the streams in the computing cluster. The same stream may have multiple phases of tasks, each phase of task may have multiple instances, and the task scheduler may be responsible for operations such as resource distribution and task monitoring of the tasks in the same stream.

In the computing cluster, each machine may be assigned to run a stream computing service or execute an off-line computing job, both of which may share the storage resources of the cluster. In some embodiments, the data processing involves three functional components: a shard (a shard node), an AppContainer (a first-level computing node), and processors (common computing nodes). In this disclosure, a shard is a uniquely identified group of data records in a data stream. It provides a fixed unit of capacity for data reading/writing. The data capacity of a data stream is a function of the number of shards that included in the stream, and the total capacity of the stream is the sum of the capacities of its shards.

The shard is used to receive data of a client, and it first stores the data to the distributed file system. The data received at this layer may be used for another service at the same time, for example, for performing off-line computing in an off-line computing node, such as MapReduce. Then, the data is sent to an AppContainer (e.g., Machine 1 and Machine 2 shown in FIG. 4). The AppContainer includes a running instance of one or more Tasks, where the task is a logic processing unit in the stream computing, and one task may have multiple physical running instances.

In some implementations, the main level task is distinguished from other tasks, where the main level task is referred to as an agent task, and other tasks are also referred to as inner tasks. The inner tasks are located in the processors (e.g., Machine 3 shown in FIG. 4). Since data storing is performed by the shard, the implementation of the AppContainer may be different from the processor, where each AppContainer includes one or more shards, and the processors do not include any shard. The data storing operation may be transparent for the user, and from the user's perspective, there may be no difference between the agent task and the inner task. In some implementations, the shard responsible for the data storage operation is placed in the same AppContainer with the agent task responsible for a main level task processing. In the present disclosure, data that is stored persistently may be accessed by the off-line computing node.

In some implementations, the shard may organize the data according to a certain format when the data is stored persistently. In the present disclosure, a table corresponds to a directory of the distributed file system, and data in the same table have the same schema. Information such as a table name and a Schema may be stored in the meta service as primitive information. When the client initiates a data uploading service, a shard service may be enabled by using a corresponding table name.

In step 302, the shard node stores the data to a storage directory corresponding to the table.

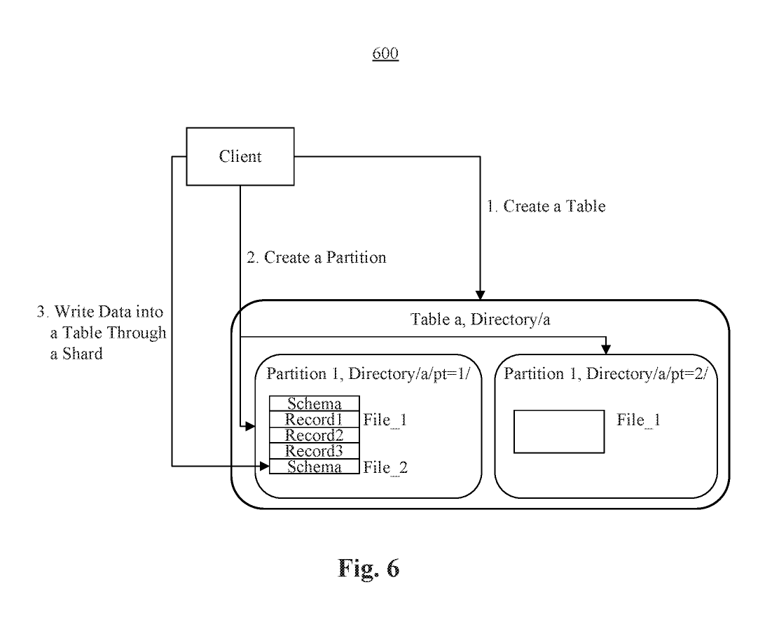

FIG. 6 is a schematic diagram 600 illustrating an exemplary data structure, consistent with some embodiments of this disclosure. As shown in FIG. 6, the user may create a table, such as Table a, through a client and designates a corresponding directory such as /a/pt=1/, /a/pt=2/. The client may write data, such as records 1-3, into the table through the shard.

When receiving the data of the client, the shard may search the meta service for a schema corresponding to the table based on a table name, verify a type of each field of the data by using the schema, determine whether the data is valid, and when the verification is passed, store the data to a storage directory corresponding to the table.

In some implementations, the table is divided into one or more partitions, and each partition corresponds to a sub-directory in the storage directory. For example, when a table is created, the user may designate a partition column and create partitions for the data according to a value of the column. A partition includes data whose value of partition column meets the partitioning condition. In some implementations, data arrives at the distributed system continuously, and the data generally includes time of generating the data. Thus, the data may be partitioned according to the time. For example, a partition “20150601” includes data whose generation time is Jun. 1, 2015.

In some implementations, a header of a file stores a schema of a table, and during encapsulation, the data meeting the partition may be encapsulated into one or more files according to the file size and/or time, and the one or more files are stored in storage sub-directories corresponding to the partitions. The partition may be performed according to the size of the file, and as a result, the computation burden during data writing may be reduced. The partition may also be performed according to time. For example, files from 13 o'clock to 14 o'clock and files from 14 o'clock to 15 o'clock may be stored separately, and the files may be divided into a number of segments, each having a duration of 5 minutes. In doing so, the amount of data from 13 o'clock to 14 o'clock falling into the files from 14 o'clock to 15 o'clock may be reduced.

In the same partition, the data is stored in a series of files having a consistent prefix and ascending sequence IDs. For example, files under the partition may have the same prefix with ascending file numbers. When a partition is initially created, there is no file under the partition directory. When data is written in, a file having a postfix of “1” may be created in the distributed file system. Afterwards, data recorded is written into the file, and when the file exceeds a certain file size (for example, 64M) or after a certain period of time (for example, 5 minutes), file switching may be performed, i.e., the file having the postfix “1” is closed, and a file having a postfix “2” is created, and so on. The same prefix enables that one file number is required for each partition, and a file name may be obtained by splicing according to the prefix, thereby reducing the size of the meta information. The ascending sequence IDs enable that the sequence of the files being created may be determined according to the sequence IDs of the files, without the need of opening the files.

In step 303, when the storage is successful, the shard node sends the data to each connected stream computing node to perform stream computing. If the data is persistently stored, the data is accessible by the off-line computing node.

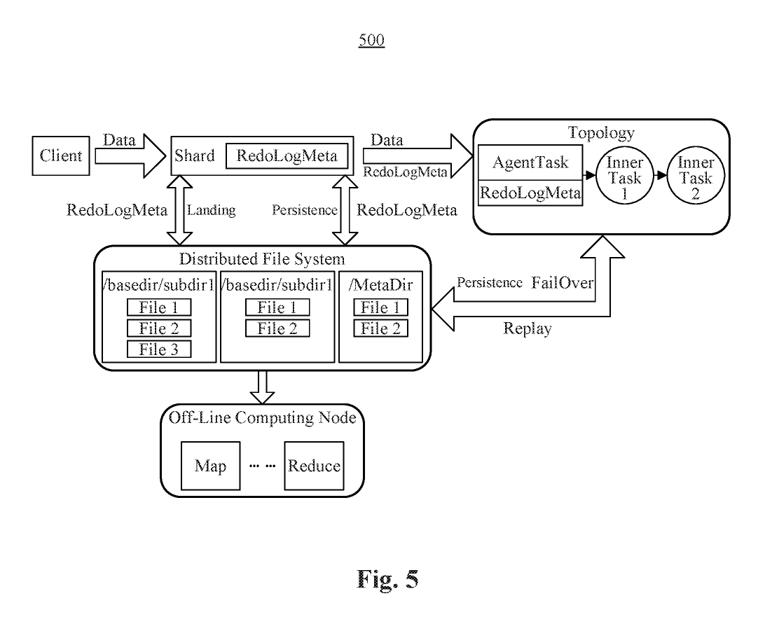

As shown in FIG. 4 and FIG. 5, a logic of stream computing implemented by each application is referred to as a topology. A topology consists of multiple computing nodes, and each computer node executes a topology subset.

Each shard may access one or more stream computing nodes, and after the data is persistently stored, the shard may forward the data to each back-end stream computing node to perform real-time stream computing. In doing so, when a stream computing node is abnormal or breaks down, communication between the shard and other stream computing nodes will not be affected.

In some implementations, to ensure the security of the distributed system, the task may run in a restricted sandbox environment and may be prohibited from accessing the network. Each level of task sends data upward to a local AppContainer or processor for transferring, and the local AppContainer or processor then sends data to the next level of Task.

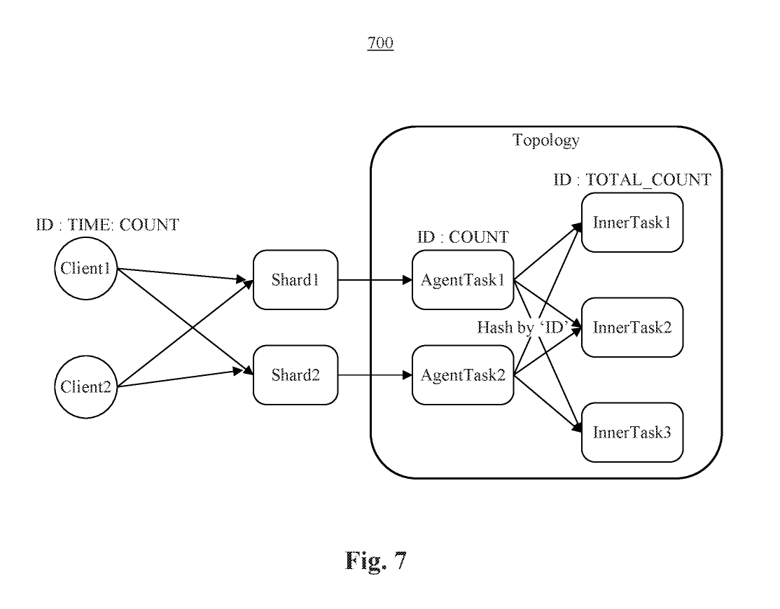

FIG. 7 is a schematic diagram 700 illustrating an exemplary stream computing method, consistent with some embodiments of this disclosure. It should be understood that the real-time stream computing method performed by the stream computing node may differ in different service fields. As shown in FIG. 7, the stream computing node may be used to perform aggregation analysis.

In one example, assuming an e-commerce platform adopts stream computing nodes to compute a real-time total sales of products, each time when a transaction is completed, a piece of log data in a format such as “product ID: time: sales volume” may be generated. The log data is imported from a client (e.g., Client 1 and Client 2 shown in FIG. 7) into the distributed system in real time through a Restful API. For sake of simplicity, the description of a tunnel server and corresponding tunneling function is omitted in this example.

The shard (e.g., Shard 1 and Shard 2 shown in FIG. 7) performs persistent storage on the data, and forwards the data to an agent task (e.g., AgentTask 1 and AgentTask 2 shown in FIG. 7) of the stream computing node. The agent task extracts a product ID and a sales count from the log, performs a hash operation by using the product ID as a key, generates intermediate data according to an obtained hash value, and forwards the intermediate data to a corresponding inner task (e.g., InnerTask1, InnerTask2 and an InnerTask3 shown in FIG. 7). The Inner Task receives the intermediate data transferred by the Agent Task and accumulates the sales count corresponding to the product ID, so as to obtain the real-time total sales count TOTAL_COUNT.

In the method 300, a shard node stores data uploaded by a client directed to a table to a storage directory corresponding to the table, and sends the data to each connected stream computing node to perform stream computing when the data is successfully stored, such that the data may be shared by an off-line computing node and a real-time stream computing node at the same time without relying on a message middleware. In doing so, the system complexity, storage cost, error probability, and processing delay can be reduced compared with the message queue mechanism.

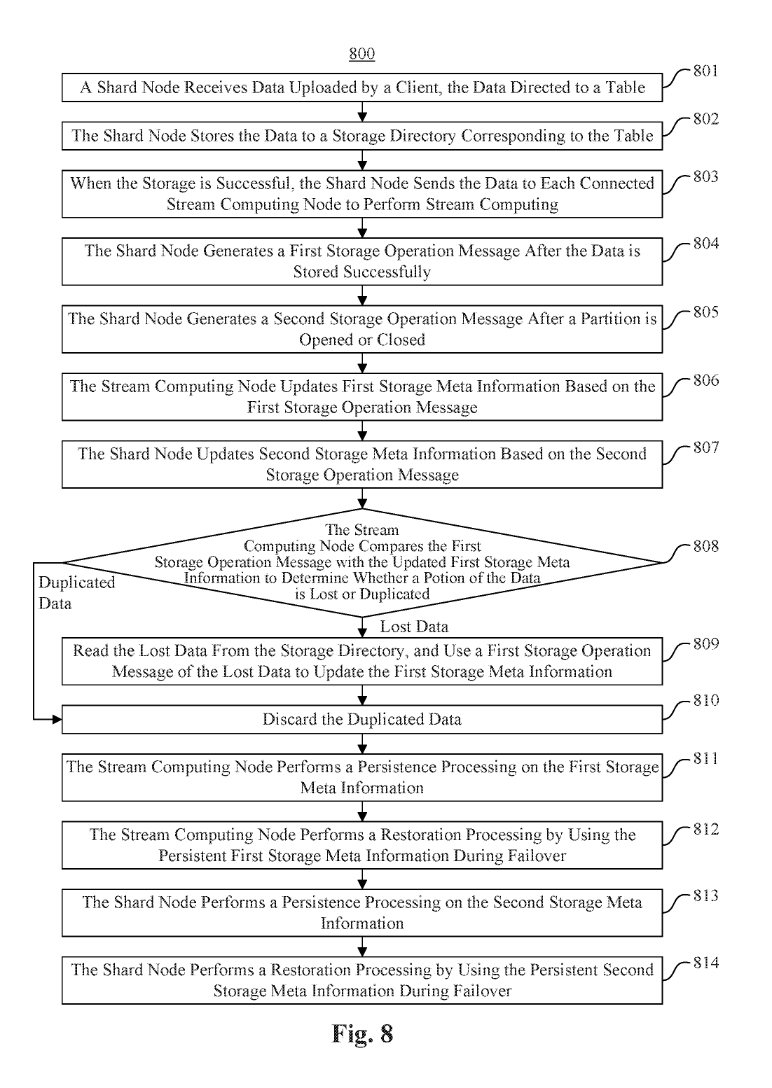

FIG. 8 is a flowchart of an exemplary method 800 for distributed data processing, consistent with some embodiments of this disclosure. Referring to FIG. 8, the method 800 includes the following steps.

In step 801, a shard node receives data uploaded by a client, the data directed to a table.

In step 802, the shard node stores the data to a storage directory corresponding to the table.

In step 803, when the storage is successful, the shard node sends the data to each connected stream computing node to perform stream computing.

In step 804, the shard node generates a first storage operation message after the data is stored successfully. For example, after the data is successfully stored, a shard may forward the data to each stream computing node it has access to, and a RedoLog solution with separate files for reading and writing may be used in this step.

In some implementations, the shard generates a first storage operation message named RedoLogMessage for each piece of successfully stored data. The first storage operation message may include one or more parameters as follows: a file to which the data belongs, an offset of the file to which the data belongs, and a storage sequence ID generated according to a storage order (for example, monotone increasing).

In step 805, the shard node generates a second storage operation message after a partition is opened or closed. For example, when a partition is being opened or closed, the shard may record in a file named RedoLogMeta information of the partition opened this time, and generate a second storage operation message named RedoLogMessage. The second storage operation message may include one or more parameters as follows: a file (Loc) to which the data belongs, an offset of the file to which the data belongs, and a storage sequence ID (SequenceID) generated according to a storage order (for example, monotone increasing). In some implementations, the second storage operation message and the first storage operation message share the same storage sequence ID. The matching addressing of data operation and partitioning operation enables that operations on the shard within a period of time may be restored by retransmitting a series of successive RedoLogMessages.

In step 806, the stream computing node updates first storage meta information based on the first storage operation message. In some implementations, to avoid interferences between the stream computing nodes, the shard may also send the corresponding first storage operation message named RedoLogMessage to the stream computing nodes when sending the data.

The agent task of each stream computing node may maintain the first storage meta information named RedoLogMeta, which stores a state of each partition when data is written the last time. The shard may forward each generated RedoLogMessage to the agent task of each stream computing node thereon along with the data. The agent task updates respective RedoLogMeta stored in a memory thereof according to the RedoLogMessage, maintains a state of data transmission between the agent task and the shard, and restores the state of the agent task according to the information when fail over occurs, thereby not affecting other stream computing nodes or shards.

In some implementations, the stream computing node may determine whether a first target storage operation message exists in the first storage meta information. If a first target storage operation message exists in the first storage meta information, the stream computing node may replace the existing first target storage operation message with the newly received first storage operation message. If no first target storage operation message exists in the first storage meta information, the stream computing node may add the received first storage operation message to the first storage meta information.

An example of a first storage operation message is shown in Table 1. As shown in Table 1, the first storage operation message includes a file (Loc) to which the data belongs, an offset of the file to which the data belongs, and a storage sequence ID (SequenceID) generated according to a storage order.

TABLE 1
An example of first storage operation message

| PardID | Loc | Offset | SequenceID |
|---|---|---|---|
| 2 | /a/2/file_2 | 112 | 11 |

An example of first storage meta information is shown in Table 2. As shown in Table 2, the first storage meta information includes the same file “/a/2/file_2” as that of the first storage operation message shown in Table 1.

TABLE 2
An example of first storage meta information

| PardID | Loc | Offset | SequenceID |
|---|---|---|---|
| 1 | /a/1/file_1 | 50 | 7 |
| 2 | /a/2/file_2 | 90 | 10 |
| 3 | /a/3/file_3 | 0 | 9 |

The newly received first storage operation message represents the latest operation on the file “/a/2/file_2” to replace the existing first storage operation message representing an old operation. The updated first storage meta information is shown in Table 3. As shown in Table 3, the first storage meta information is updated to include the newly received operation message for the file “/a/2/file_2.”

TABLE 3
An example of updated first storage meta information

| PardID | Loc | Offset | SequenceID |
|---|---|---|---|
| 1 | /a/1/file_1 | 50 | 7 |
| 2 | /a/2/file_2 | 112 | 11 |
| 3 | /a/3/file_3 | 0 | 9 |

As another example, a first target storage operation message for the file “/a/2/file_1” is shown in Table 4.

TABLE 4
Another example of first storage operation message

| PardID | Loc | Offset | SequenceID |
|---|---|---|---|
| 4 | /a/2/file_1 | 0 | 11 |

Another example of first storage meta information is shown in Table 5. As shown in Table 5, the first storage meta information does not include the file “/a/2/file_1” in the first storage operation message shown in Table 4.

TABLE 5
Another example of first storage meta information

| PardID | Loc | Offset | SequenceID |
|---|---|---|---|
| 1 | /a/1/file_1 | 50 | 7 |
| 2 | /a/2/file_2 | 90 | 10 |
| 3 | /a/3/file_1 | 0 | 9 |

When the first storage meta information and the first storage operation message do not have the same file, the first storage operation message representing the latest operation on the file “/a/2/file_1” may be added to the first storage meta information. The updated first storage meta information is shown in Table 6. As shown in Table 6, the first storage meta information is updated to include the newly received operation message for the file “/a/2/file_1.”

TABLE 6
Another example of updated first storage meta information

| PardID | Loc | Offset | SequenceID |
|---|---|---|---|
| 1 | /a/1/file_1 | 50 | 7 |
| 2 | /a/2/file_2 | 90 | 10 |
| 3 | /a/3/file_3 | 0 | 9 |
| 4 | /a/2/file_1 | 0 | 11 |

In step 807, the shard node updates second storage meta information based on a second storage operation message. For example, the shard updates a state of second storage meta information named RedoLogMeta in a memory based on a RedoLogMessage (the second storage operation message) generated in each open or close operation, so as to store states of all partitions currently open in the shard. The second storage meta information RedoLogMeta stores the state of each partition when the data is written the last time.

In some implementations, the shard may determine whether a second target storage operation message exists in the second storage meta information. If a second target storage operation message exists in the second storage meta information, the shard may replace the existing second target storage operation message with the newly generated second storage operation message. If no second target storage operation message exists in the second storage meta information, the shard may add the generated second storage operation message to the second storage meta information.

In step 808, the stream computing node compares the first storage operation message with the updated first storage meta information to determine whether a portion of the data is lost or duplicated. When a portion of the data is lost, step 809 is performed, and when a portion of the data is duplicated, step 810 is performed.

In some implementations, the sequence ID is distributed in the range of the shard and is shared between different partitions. The sequence IDs between successive data are monotone successive, and thus, if the RedoLogMessage received by the stream computing node and the updated RedoLogMeta are not successive, it may indicate that a portion of the data is lost or duplicated, and the portion of data needs to be retransmitted or discarded to restore a normal state. For example, when a storage sequence ID of the first storage operation message is greater than a target storage sequence ID, it is determined that a portion of data is lost, and when the storage sequence ID of the first storage operation message is less than the target storage sequence ID, it is determined that a portion of data is duplicated, where the target storage sequence ID is a next storage sequence ID of the latest storage sequence ID in the first storage meta information.

For example, the first storage meta information is shown in Table 7. As shown in Table, 7, the latest storage sequence ID for the file “/a/2/file_2” in the RedoLogMeta is 7. Correspondingly, a target storage sequence ID for the file “/a/2/file_2” is 8, and it indicates that the next RedoLogMessage for the file “/a/2/file_2” should be a RedoLogMessage of data whose storage sequence ID is 8. If the sequence ID of the currently received RedoLogMessage is 9, greater than the target storage sequence ID, it indicates that a portion of the data is lost. If the sequence ID of the currently received RedoLogMessage is 6, less than the target storage sequence ID, it indicates that a portion of the data is duplicated.

TABLE 7
Another example of first storage meta information

| PardID | Loc | Offset | SequenceID |
|---|---|---|---|
| 1 | /a/1/file_1 | 50 | 6 |
| 2 | /a/2/file_2 | 90 | 7 |
| 3 | /a/3/file_1 | 0 | 5 |

In step 809, the lost data is read from the storage directory, and a first storage operation message of the lost data is used to update the first storage meta information. In some implementations, a first candidate storage sequence ID between the storage sequence ID of the first storage operation message and the latest storage sequence ID of the first storage meta information may be computed. A partition may be identified in the first storage meta information, and data corresponding to a candidate storage sequence ID may be read from a storage sub-directory corresponding to the partition.

When updating the first storage meta information, it may be determined whether a first target storage operation message of the lost data exists in the first storage meta information. If a first target storage operation message of the lost data exists in the first storage meta information, the existing first target storage operation message is replaced with the newly received first storage operation message; otherwise, the newly received first storage operation message is added to the first storage meta information.

For example, as shown in Table 7, the latest storage sequence ID for the file “/a/2/file_2” in the RedoLogMeta is 7, and if the sequence ID of the currently received RedoLogMeta is 9, the first candidate storage sequence ID is 8. An example of distributed file system is shown in Table 8. If the currently open partition recorded in the RedoLogMeta is Part2, data with a sequence ID of 8 may be read from the Part2, and a RedoLogMessage may be sent to update the RedoLogMeta.

TABLE 8
An example of distributed file system

| Part1 | Part2 | Part3 |
|---|---|---|
| Record SequenceID: 1 | Record SequenceID: 2 | Record SequenceID: 3 |
| Record SequenceID: 4 | Record SequenceID: 7 | Record SequenceID: 5 |
| Record SequenceID: 6 | Record SequenceID: 8 | Record SequenceID: 9 |

An example RedoLogMessage of the data with a sequence ID of 8 is shown in Table 9, and the updated RedoLogMeta is shown in Table 10. It can be seen in Table 10 that the data with a sequence ID of 8 is added to the updated RedoLogMeta.

TABLE 9
An example RedoLogMessage

| PardID | Loc | Offset | SequenceID |
|---|---|---|---|
| 2 | /a/2/file_2 | 112 | 8 |

TABLE 10
An example of updated RedoLogMeta

| PardID | Loc | Offset | SequenceID |
|---|---|---|---|
| 1 | /a/1/file_1 | 50 | 6 |
| 2 | /a/2/file_2 | 112 | 8 |
| 3 | /a/3/file_1 | 0 | 5 |

In step 810, the duplicated data is discarded. In the case of a failover or a packet loss caused by the network, the data needs to be retransmitted, and as a result, duplicated data may exist. In this case, the duplicated data is discarded directly.

In step 811, the stream computing node performs a persistence processing on the first storage meta information. The first storage meta information is stored in the memory, and once the machine is down or restarts, the first storage meta information in the memory will be lost. In some implementations, in order to restore the first storage meta information during the failover, the first storage meta information (MetaFile) may be stored to a magnetic disk in the distributed file system (for example, a MetaDir directory) as a CheckPoint. The persistence processing may be performed periodically, and may also be performed when a certain condition is met, which is not limited by the present disclosure.

In step 812, the stream computing node performs a restoration processing by using the persistent first storage meta information during failover. For example, the persistent first storage meta information (e.g., the CheckPoint) may be loaded to the memory, and a deserialization may be performed on a CheckPoint to restore the state of the RedoLogMeta when the last CheckPoint was generated.

Since the system may break down between two CheckPoints, or the machine may be down between two CheckPoints, information after the last CheckPoint may be lost if there is no extra measure, including data written after the last CheckPoint and the partition opened or closed after the last CheckPoint. For data written after the last CheckPoint, a RedoLogMessage may be generated after the data is stored successfully, and thus, the data may be restored by reading the RedoLogMessage. For the partition opened or closed after the last CheckPoint, a file named RedoLogMeta may be maintained to record the operation of opening and/or closing the partition. For example, the first storage meta information RedoLogMeta may identify a currently open partition, and the latest storage sequence ID may be searched for from a storage sub-directory corresponding to the currently open partition. A candidate storage sequence ID between the latest storage sequence ID in the storage sub-directory and the latest storage sequence ID of the first storage meta information may be then computed. Correspondingly, the first storage operation message of data with the candidate storage sequence is used to update the first storage meta information.

In some implementations, multiple files may be used for storing the RedoLogMessage and the related information. The files may be named sequentially, so as to indicate a sequence in an approximate range. For example, file 1 stores RedoLogMessage of data having sequence IDs 1-10, file 2 stores RedoLogMessage of data having sequence IDs 11-20, thereby indicating that sequences of the RedoLogMessage in the file 1 are earlier than those in the file 2 without requiring opening the files. If the RedoLogMes sage of the data having a SequenceId of 8 is being searched for, file 1 may then be opened.

An example of the persistent RedoLogMessage is shown in Table 11, and an example of the distributed file system is shown in Table 12.

TABLE 11
An example of persistent RedoLogMessage

| PardID | Loc | Offset | SequenceID |
|---|---|---|---|
| 1 | /a/1/file_1 | 50 | 6 |
| 2 | /a/2/file_2 | 90 | 7 |
| 3 | /a/3/file_1 | 0 | 5 |

TABLE 12
An example of distributed file system

| Part1 | Part2 | Part3 |
|---|---|---|
| Record SequenceID: 1 | Record SequenceID: 2 | Record SequenceID: 3 |
| Record SequenceID: 4 | Record SequenceID: 7 | Record SequenceID: 5 |
| Record SequenceID: 6 | Record SequenceID: 8 | Record SequenceID: 9 |

In one example, assuming the currently open partition recorded in the RedoLogMeta is Part2, a sequence ID of the candidate storage sequence ID is 8, data having a sequence ID of 8 may be read from the Part2, and a corresponding RedoLogMessage may be used to update the RedoLogMeta. The updated RedoLogMeta is shown in Table 13. As shown in Table 13, the sequence ID for the file “/a/2/file_2” is updated to 8.

TABLE 13
An example of updated RedoLogMeta

| PardID | Loc | Offset | SequenceID |
|---|---|---|---|
| 1 | /a/1/file_1 | 50 | 6 |
| 2 | /a/2/file 2 | 112 | 8 |
| 3 | /a/3/file 1 | 0 | 5 |

In step 813, the shard node performs a persistence processing on the second storage meta information. The second storage meta information is stored in the memory, and once the machine is down or the process restarts, the second storage meta information in the memory may be lost. In some implementations, in order to restore the second storage meta information during the failover, the second storage meta information may be stored to a magnetic disk in the distributed file system as a CheckPoint. The persistence processing may be performed periodically, and may also be performed when a certain condition is met, which is not limited by the present disclosure.

In step 814, the shard node performs a restoration processing by using the persistent second storage meta information during failover. For example, the persistent second storage meta information (e.g., the CheckPoint) may be loaded to the memory, and a deserialization may be performed on a CheckPoint to restore the state of the RedoLogMeta when the last CheckPoint was generated.

Since the system may break down between two CheckPoints, or the machine may be down between two CheckPoints, information after the last CheckPoint may be lost if there is no extra measure, including data written after the last CheckPoint and the partition opened or closed after the last CheckPoint. For data written after the last CheckPoint, a RedoLogMessage may be generated after the data is stored successfully, and thus, the data may be restored by reading the RedoLogMessage. For the partition opened or closed after the last CheckPoint, a file named RedoLogMeta may be maintained to record the operation of opening and/or closing the partition. For example, the second storage meta information may identify a currently open partition, and the latest storage sequence ID may be searched for from a storage sub-directory corresponding to the currently open partition. A candidate storage sequence ID between the latest storage sequence ID in the storage sub-directory and the latest storage sequence ID of the second storage meta information may be then computed. Correspondingly, the second storage operation message of data with the candidate storage sequence is used to update the second storage meta information.

In the method 800, by updating the first and second storage meta information based on the storage operation messages, data loss or duplication may be reduced from data transmission between the shard node and the stream computing node. Further, the method 800 allows the stream computing nodes to realize data sharing and state isolation, such that network abnormality or break down of one stream computing node may not affect data writing of the shard node or data reading of other stream computing nodes. Moreover, the shard node and the stream computing node may restore their states according to the persistent storage operation messages without requiring data to be retransmitted from the source, thereby achieving rapid restoring.

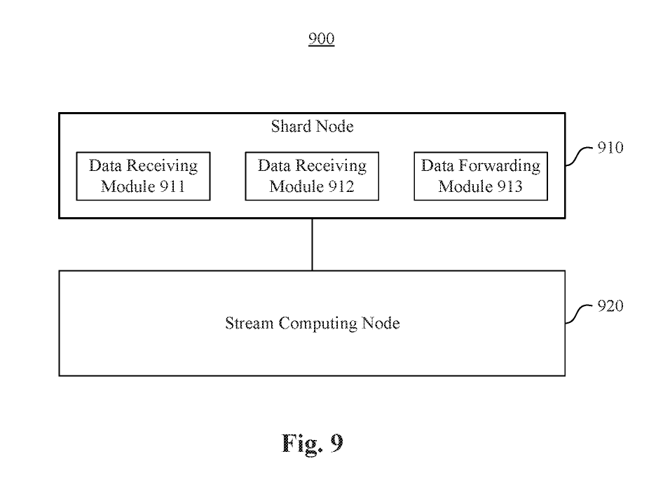

FIG. 9 is a block diagram of an exemplary system 900 for distributed data processing, consistent with some embodiments of this disclosure. Referring to FIG. 9, the system 900 includes one or more shard nodes 910 and one or more stream computing nodes 920. The shard node 910 includes a data receiving module 911, a data storing module 912, and a data forwarding module 913.

The data receiving module 911 is configured to receive data uploaded by a client, the data directed to a table. The data storing module 912 is configured to store the data to a storage directory corresponding to the table. The data forwarding module 913 is configured to, when the storage is successful, send the data to each connected stream computing node 920 to perform stream computing.

In some embodiments, the data storing module 912 may further include a schema searching sub-module, a schema verifying sub-module, and a storing sub-module. The schema searching sub-module is configured to search for a schema corresponding to the table. The schema verifying sub-module is configured to verify the data by using the schema. The storing sub-module is configured to store the data in the storage directory corresponding to the table when the verification is successful.

In some embodiments, the table is divided into one or more partitions, and each partition corresponds to a storage sub-directory in the storage directory. The data storing module 912 may further include a file encapsulating sub-module and a file storing sub-module. The file encapsulating sub-module is configured to encapsulate data meeting the partitions into one or more files according to the file size and/or time. The file storing sub-module is configured to store the one or more files to the storage sub-directories corresponding to the partitions.

In some embodiments, the shard node 910 may further include a first storage operation message generating module and a second storage operation message generating module. The first storage operation message generating module is configured to generate a first storage operation message after data is stored successfully. The second storage operation message generating module is configured to generate a second storage operation message after a partition is opened or closed. The first storage operation message may include one or more parameters as follows: a file to which the data belongs, an offset of the file to which the data belongs, and a storage sequence ID generated according to a storage order. The second storage operation message includes one or more parameters as follows: a file to which the data belongs, an offset of the file to which the data belongs, and a storage sequence ID generated according to a storage order.

In some embodiments, the stream computing node 920 may include a first updating module configured to update first storage meta information based on the first storage operation message. The shard node 910 may further include a second updating module configured to update second storage meta information based on the second storage operation message.

In some embodiments, the first updating module may include a first target storage operation message determining sub-module, a first replacing sub-module, and a first adding sub-module. The first target storage operation message determining sub-module is configured to determine whether a first target storage operation message exists in the first storage meta information. If a first target storage operation message exists in the first storage meta information, the first target storage operation message determining sub-module invokes the first replacing sub-module; otherwise, the first target storage operation message determining sub-module invokes a first adding sub-module. The first target storage operation message is associated with the same file as that of the first storage operation message representing data. The first replacing sub-module is configured to replace the first target storage operation message with the first storage operation message. The first adding sub-module is configured to add the first storage operation message to the first storage meta information.

The second updating module may include a second target storage operation message determining sub-module, a second replacing sub-module, and a second adding sub-module. The second target storage operation message determining sub-module is configured to determine whether a second target storage operation message exists in the second storage meta information. If yes, the second target storage operation message determining sub-module invokes the second replacing sub-module; and if no, the second target storage operation message determining sub-module invokes the second adding sub-module. The second target storage operation message is associated with the same file as that of the second storage operation message representing data. The second replacing sub-module is configured to replace the second target storage operation message with the second storage operation message. The second adding sub-module is configured to add the second storage operation message to the second storage meta information.

In some embodiments, the stream computing node 920 may further include a data checking module, a reading module, and a discarding module. The data checking module is configured to compare the first storage operation message with the updated first storage meta information to determine whether a portion of the data is lost or duplicated. When a portion of the data is lost, the data checking module invokes the reading module, and when a portion of the data is duplicated, the data checking module invokes the discarding module. The reading module is configured to read the lost data from the storage directory, and use a first storage operation message of the lost data to update the first storage meta information. The discarding module is configured to discard the duplicated data.

In some embodiments, the data checking module may include a loss determining sub-module and a duplication determining sub-module. The loss determining sub-module is configured to, when a storage sequence ID of the first storage operation message is greater than a target storage sequence ID, determine that data is lost. The duplication determining sub-module is configured to, when the storage sequence ID of the first storage operation message is less than the target storage sequence ID, determine that data is duplicated. The target storage sequence ID is a next storage sequence ID of the latest storage sequence ID in the first storage meta information.

In some embodiments, the reading module may include a first candidate storage sequence ID computing sub-module and a partition data reading sub-module, when the first storage meta information identifies a currently open partition. The first candidate storage sequence ID computing sub-module is configured to compute a first candidate storage sequence ID between the storage sequence ID of the first storage operation message and the latest storage sequence ID of the first storage meta information. The partition data reading sub-module is configured to read data corresponding to the first candidate storage sequence ID from a storage sub-directory corresponding to the currently open partition.

In some embodiments, the stream computing node 920 may further include a first persistence module and a first restoring module. The first persistence module is configured to perform a persistence processing on the first storage meta information. The first restoring module is configured to perform a restoration processing by using the persistent first storage meta information during failover. The shard node 910 may further include a second persistence module and a second restoring module. The second persistence module is configured to perform a persistence processing on the second storage meta information. The second restoring module is configured to perform a restoration processing by using the persistent second storage meta information during failover.

In some embodiments, the first restoring module may include a first loading sub-module, a first storage sequence ID searching sub-module, a first storage meta information updating sub-module, and a second candidate storage sequence ID computing sub-module. The second storage meta information identifies a currently open partition. The first loading sub-module is configured to load the persistent first storage meta information. The first storage sequence ID searching sub-module is configured to search for a latest storage sequence ID from a storage sub-directory corresponding to the currently open partition. The second candidate storage sequence ID computing sub-module is configured to compute a second candidate storage sequence ID between the latest storage sequence ID in the storage sub-directory and the latest storage sequence ID of the first storage meta information. The first storage meta information updating sub-module is configured to update the first storage meta information based on the first storage operation message of data having the second candidate storage sequence ID.

In some embodiments, the second restoring module may include a second loading sub-module, a second storage sequence ID searching sub-module, a second storage meta information updating sub-module, and a third candidate storage sequence ID computing sub-module. The second loading sub-module is configured to load the persistent second storage meta information. The second storage sequence ID searching sub-module is configured to search for a latest storage sequence ID from a storage sub-directory corresponding to the currently open partition. The third candidate storage sequence ID computing sub-module is configured to compute a third candidate storage sequence ID between the latest storage sequence ID in the storage sub-directory and the latest storage sequence ID of the second storage meta information. The second storage meta information updating sub-module is configured to update the second storage meta information based on the second storage operation message of data having the third candidate storage sequence ID.

In exemplary embodiments, a non-transitory computer-readable storage medium including instructions is also provided, and the instructions may be executed by a computing device (such as a personal computer, a server, a network device, or the like), for performing the above-described methods. The device may include one or more processors (CPUs), an input/output interface, a network interface, and/or a memory.

For example, the non-transitory computer-readable storage medium may be read-only memory (ROM), random access memory (RAM), Compact Disc Read-Only Memory (CD-ROM), magnetic tape, flash memory, floppy disk, a register, a cache, and optical data storage device, etc. Examples of RAM include Phase Change Random Access Memory (PRAM), Static Random Access Memory (SRAM), Dynamic Random Access Memory (DRAM), and other types of RAM

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The illustrated steps in the above-described figures are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments.

One of ordinary skill in the art will understand that the above described embodiments can be implemented by hardware, software, or a combination of hardware and software. If implemented by software, it may be stored in the above-described computer-readable medium. The software, when executed by the processor can perform the disclosed methods. The computing units (e.g., the modules and sub-modules) and the other functional units described in this disclosure can be implemented by hardware, or software, or a combination of hardware and software for allowing a specialized device to perform the functions described above. One of ordinary skill in the art will also understand that multiple ones of the above described units may be combined as one unit, and each of the above described modules/units may be further divided into a plurality of sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes may be made without departing from the scope thereof. It is intended that the scope of the invention should only be limited by the appended claims.

What is claimed is:

1. A distributed data processing method, comprising:
receiving, by a shard node, data uploaded by a client, wherein the data is directed to a table;
storing, by the shard node, the data to a storage directory corresponding to the table; and
when the storing is successful, sending, by the shard node, the data to a connected stream computing node to perform stream computing.

2. The method according to claim 1, wherein storing the data to the storage directory comprises:
searching for a schema corresponding to the table;
verifying the data by using the schema; and
when the verification is passed, storing the data to the storage directory corresponding to the table.

3. The method according to claim 1, wherein the table is divided into one or more partitions, each partition corresponding to a storage sub-directory in the storage directory, and wherein storing the data to the storage directory comprises:
encapsulating a portion of the data into one or more files according to a predetermined file size or duration; and
storing the one or more files to the storage sub-directories corresponding to the partitions.

4. The method according to claim 1, further comprising:
generating, by the shard node, a first storage operation message after data is stored successfully; and
generating, by the shard node, a second storage operation message after a partition is opened or closed, wherein each of the first storage operation message and the second storage operation message includes one or more of the following: a file to which the data belongs, an offset of the file to which the data belongs, and a storage sequence ID generated according to a storage order.

5. The method according to claim 4, further comprising:
updating, by the stream computing node, first storage meta information based on the first storage operation message; and
updating, by the shard node, second storage meta information based on the second storage operation message.

6. The method according to claim 5, wherein updating the first storage operation message comprises:
determining whether a first target storage operation message exists in the first storage meta information, the first target storage operation message being associated with a same file as the first storage operation message;
if the first target storage operation message exists in the first storage meta information, replacing the first target storage operation message with the first storage operation message; and
if the first target storage operation message does not exist in the first storage meta information, adding the first storage operation message to the first storage meta information.

7. The method according to claim 5, further comprising:
comparing, by the stream computing node, the first storage operation message with the updated first storage meta information to determine whether a portion of the data is lost or duplicated;
when the portion of the data is lost, reading the lost data from the storage directory, and using a first storage operation message of the lost data to update the first storage meta information; and
when the portion of the data is duplicated, discarding the duplicated data.

8. The method according to claim 7, wherein comparing the first storage operation message with the updated first storage meta information to determine whether data is lost or duplicated comprises:
when a storage sequence ID of the first storage operation message is greater than a target storage sequence ID, determining that data is lost; and
when the storage sequence ID of the first storage operation message is less than the target storage sequence ID, determining that data is duplicated, wherein the target storage sequence ID is a storage sequence ID next to a latest storage sequence ID in the first storage meta information.

9. The method according to claim 7, wherein the first storage meta information identifies an open partition, and wherein reading the lost data from the storage directory comprises:
computing a first candidate storage sequence ID based on the storage sequence ID of the first storage operation message and a latest storage sequence ID in the first storage meta information; and
reading data corresponding to the first candidate storage sequence ID from a storage sub-directory corresponding to the open partition.

10. The method according to claim 5, further comprising:
performing, by the stream computing node, a persistence processing on the first storage meta information;
performing, by the stream computing node, a restoration processing by using persistent first storage meta information during failover;
performing, by the shard node, a persistence processing on the second storage meta information; and
performing, by the shard node, a restoration processing by using persistent second storage meta information during failover.

11. The method according to claim 10, wherein the first storage meta information identifies an open partition, and wherein performing the restoration processing by using the persistent first storage meta information during failover comprises:
loading the persistent first storage meta information;
searching for a latest storage sequence ID from a storage sub-directory corresponding to the open partition;
computing a second candidate storage sequence ID based on the latest storage sequence ID in the storage sub-directory and a latest storage sequence ID in the first storage meta information; and
using a first storage operation message of data having the second candidate storage sequence ID to update the first storage meta information.

12. A distributed data processing system comprising: one or more shard nodes and one or more stream computing nodes, wherein each of the shard nodes comprises:
a data receiving module configured to receive data uploaded by a client, wherein the data is directed to a table;
a data storing module configured to store the data to a storage directory corresponding to the table; and
a data forwarding module configured to, when the storage is successful, send the data to a connected stream computing node to perform stream computing.

13. The distributed data processing system of claim 12, wherein each of the shard nodes further comprises:
a first storage operation message generating module configured to generate a first storage operation message after data is stored successfully; and
a second storage operation message generating module configured to generate a second storage operation message after a partition is opened or closed, wherein each of the first storage operation message and the second storage operation message includes one or more of the following: a file to which the data belongs, an offset of the file to which the data belongs, and a storage sequence ID generated according to a storage order.

14. The distributed data processing system of claim 13, wherein each of the stream computing nodes further comprises a first updating module configured to update first storage meta information based on the first storage operation message, and wherein each of the shard nodes further comprises a second updating module configured to update second storage meta information based on the second storage operation message.

15. The distributed data processing system of claim 14, wherein each of the stream computing nodes further comprises:
a data checking module configured to compare the first storage operation message with the updated first storage meta information to determine whether a portion of the data is lost or duplicated;
a reading module configured to, when the portion of the data is lost, read the lost data from the storage directory, and use a first storage operation message of the lost data to update the first storage meta information; and
a discarding module configured to, when the portion of the data is duplicated, discard the duplicated data.

16. The distributed data processing system of claim 14, wherein each of the stream computing nodes further comprises:
a first persistence module configured to perform a persistence processing on the first storage meta information; and
a first restoring module configured to perform a restoration processing by using persistent first storage meta information during failover; and
wherein each of the shard nodes further comprises:
a second persistence module configured to perform a persistence processing on the second storage meta information; and
a second restoring module configured to perform a restoration processing by using persistent second storage meta information during failover.

17. A non-transitory computer readable medium that stores a set of instructions that is executable by at least one processor of a shard node to cause the shard node to perform a distributed data processing method, the distributed data processing method comprising:
receiving data uploaded by a client, wherein the data is directed to a table;
storing the data to a storage directory corresponding to the table; and
when the storing is successful, sending the data to each connected stream computing node to perform stream computing.

18. The non-transitory computer readable medium apparatus of claim 17, wherein the set of instructions that is executable by the at least one processor of the shard node to cause the shard node to further perform:
generating a first storage operation message after data is stored successfully; and
generating a second storage operation message after a partition is opened or closed, wherein each of the first storage operation message and the second storage operation message includes one or more of the following: a file to which the data belongs, an offset of the file to which the data belongs, and a storage sequence ID generated according to a storage order.

19. The non-transitory computer readable medium apparatus of claim 17, wherein storing the data to the storage directory comprises:
searching for a schema corresponding to the table;
verifying the data by using the schema; and
when the verification is passed, storing the data to the storage directory corresponding to the table.

20. The non-transitory computer readable medium apparatus of claim 17, wherein the table is divided into one or more partitions, each partition corresponding to a storage sub-directory in the storage directory, and wherein storing the data to the storage directory comprises:
encapsulating a portion of the data into one or more files according to a predetermined file size or duration; and
storing the one or more files to the storage sub-directories corresponding to the partitions.
